(19) United States
(12) Patent Application Publication
(10) Pub. No.: US 2015/0085111 A1
(43) Pub. Date: Mar. 26, 2015

(54) IDENTIFICATION USING VIDEO ANALYTICS TOGETHER WITH INERTIAL SENSOR DATA

(71) Applicant: SYMBOL TECHNOLOGIES, INC., SCHAUMBURG, IL (US)

(72) Inventor: RICHARD J LAVERY, HUNTINGTON, NY (US)

(73) Assignee: SYMBOL TECHNOLOGIES, INC., SCHAUMBURG, IL (US)

(21) Appl. No.: 14/036,142

(22) Filed: Sep. 25, 2013

(51) Int. Cl. G06K 9/00; H04W 4/02; H04N 5/14; H04N 7/18

(52) U.S. Cl. CPC G06K 9/00369; H04N 7/183; H04W 4/027; H04N 5/144; G06K 9/00335
USPC 348/143

(57) ABSTRACT

A technique for identification using video analytics together with inertial sensor data is described. The technique includes capturing video of an environment and tracking particular users in the captured video. Motion signals are received from at least one inertial sensor of at least one mobile communication device being carried by a user. The video motion of each tracked user in the captured video and the motion signals of each mobile communication device are correlated in order to associate one of the mobile communication devices with a particular tracked user in the video.

### BACKGROUND

At present, there are many techniques for the electronic monitoring of people moving in an environment, which can be used in many different commercial scenarios, such as a retail establishment, a warehouse environment, workplace, etc. For example, a video camera can be provided to monitor an environment. In this case, the camera can recognize that there are a certain number of different people in view, but the system does not know who they are and does not know anything about them.

One solution provides a monitoring technique to scan a Radio Frequency Identification (RFID) tag being worn by a worker moving within a workplace to identify and track that worker. However, this requires an array of RFID readers disposed throughout the workplace, and would not work in a retail environment for a shopper moving within a store since shoppers do not carry registered RFID tags. Another solution is to use a high resolution tracking system with facial recognition to identify and track users moving in the environment, but this requires previous identification of a person, sophisticated equipment that adds cost to the system, and is not always reliable.

Accordingly, there is a need for a technique to eliminating the aforementioned issues. Furthermore, other desirable features and characteristics of the present invention will become apparent from the subsequent detailed description and the appended claims, taken in conjunction with the accompanying drawings and the foregoing background.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a simplified block diagram of a system, in accordance with some embodiments of the present invention.

FIG. 2 is a flowchart of a method, in accordance with the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

The present invention provides a cost effective, low resolution technique to identify people in an environment using standard video analytics to track anonymous individuals, while being able to uniquely identify each person. In particular, the present invention identifies an individual by a mobile communication device they may be carrying. For example, information can be stored in a database that classifies a user by their cell phone unique identifier (UID) or Media Access Control (MAC) address that is recognized by a local area wireless network (e.g. Wi-Fi™) Specifically, if a group of people are in view of a camera, a backend server connected to the camera will know there are shoppers in their store and the camera will confirm it sees these people, but there will be no way to know who each person on the video is. The present invention can determine that these people have their phones on, and the Wi-Fi network can inform the backend server of the phone identity. Then the present invention associates the unique cell phone identity with a person recognized by video analytics, as will be detailed below. Once that association is complete, that person's movement can be tracked in the store or workplace using video (or video paired with another locationing system) and the backend server can interact with that person based on the information stored in a database (past shopping history, coupons, etc).

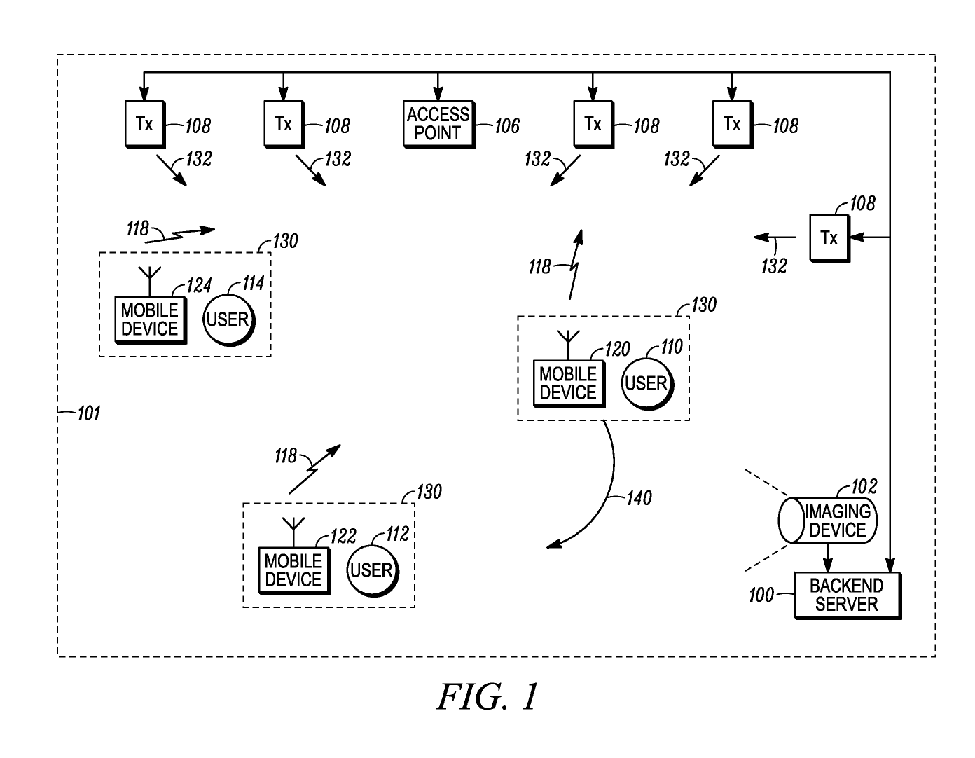

FIG. 1 is a block diagram depiction of a system that can use various optical and wireless communication technologies for identification purposes, in accordance with the present invention. The optical systems can include imaging, video, or other optical systems, as are known in the art. The wireless systems can include local and wide-area networks, or other IEEE 802.11 wireless communication system. However, it should be recognized that the present invention is also applicable to many various wireless communication systems. For example, the description that follows can apply to one or more communication networks that are IEEE 802.xx-based, employing wireless technologies such as RF, IrDA (infrared), Bluetooth, ZigBee (and other variants of the IEEE 802.15 protocol), IEEE 802.11 (any variation), IEEE 802.16 (WiMAX or any other variation), IEEE 802.11u (Wi-Fi certified Passpoint™), IEEE 802.20, Direct Sequence Spread Spectrum; Frequency Hopping Spread Spectrum; cellular/wireless/cordless telecommunication protocols; wireless home network communication protocols; paging network protocols; magnetic induction; satellite data communication protocols; wireless hospital or health care facility network protocols such as those operating in the WMTS bands; GPRS; and proprietary wireless data communication protocols such as variants of Wireless USB, any of which can be modified to implement the embodiments of the present invention. In an exemplary embodiment, the mobile device and access point are preferably compliant with at least the IEEE 802.11 specification.

The mobile communication device includes any device configured with a wireless local or wide area communication network including, but not limited to, a wide variety of consumer electronic platforms such as cellular radio telephones, smart phones, mobile stations, mobile units, mobile nodes, user equipment, user devices, mobile devices, remote unit platforms, subscriber equipment, subscriber stations, access terminals, remote terminals, terminal equipment, laptop computers, desktop computers, tablets, netbooks, personal digital assistants, and the like, all referred to herein as mobile communication devices.

FIG. 1 shows a block diagram of various entities adapted to support the inventive concepts of the preferred embodiments of the present invention. Those skilled in the art will recognize that FIG. 1 does not depict all of the equipment necessary for system to operate but only those system components and logical entities particularly relevant to the description of embodiments herein. For example, optical systems, tracking devices, servers, and wireless access points can all includes processors, communication interfaces, memories, etc. In general, components such as processors, memories, and interfaces are well-known. For example, processing units are known to comprise basic components such as, but not limited to, microprocessors, microcontrollers, memory cache, application-specific integrated circuits (ASICs), and/or logic circuitry. Such components are typically adapted to implement algorithms and/or protocols that have been expressed using high-level design languages or descriptions, expressed using computer instructions, expressed using messaging logic flow diagrams.

Thus, given an algorithm, a logic flow, a messaging/signaling flow, and/or a protocol specification, those skilled in the art are aware of the many design and development techniques available to implement a processor that performs the given logic. Therefore, the entities shown represent a known system that has been adapted, in accordance with the description herein, to implement various embodiments of the present invention. Furthermore, those skilled in the art will recognize that aspects of the present invention may be implemented in and across various physical components and none are necessarily limited to single platform implementations. For example, the correlation and association aspects of the present invention may be implemented in any of the devices listed above or distributed across such components. It is within the contemplation of the invention that the operating requirements of the present invention can be implemented in software, firmware or hardware, with the function being implemented in a software processor (or a digital signal processor) being merely a preferred option.

Referring back to FIG. 1, several users 110, 112, 114 can be moving in a defined area 101 of an environment. For example, each user can be a customer shopping within the defined area of a retail store. Similarly, the users could be workers moving within the defined area 101 of a workplace or other environment, such as a warehouse, factory, etc. It is envisioned that some of the users will be carrying a mobile communication device 120, 122, 124 on their person, and that each user/device will travel through the environment as a unit 130.

An imaging device 102 is used to track the observed relative positions and natural motions of the people in the defined area. The imaging device 102 can be a standard video system, a two or three dimensional time-of-flight or structured light depth camera or other optical sensor(s). The imaging device is operable to detect a position and movement of users in the field of view. In particular, the imaging device and backend server can capture and derive scene motion vectors to define and record the movements of the particular users captured in the video.

In one embodiment, the imaging device is an optical system such as a standard video analytics system connected to a backend server 100 operable to analyze the video captured by the imaging device and recognize and track particular anonymous individuals in the video. The optical system can be a ceiling-mounted camera(s) system, for example, with a clear view of the defined area 101 that is not blocked by objects on the floor of the environment. It should be noted that the optical system need not attempt to identify the person at all. However, the imaging device should be able to keep track of particular users by distinguishing that user's shape, outline, or other visually distinguishing features such as a graphic design or specific colors being worn by the user.

Further, as the user's communication device moves with the user 130, an inertial sensor, such as an accelerometer or gyroscope of each communication device 120, 122, 124 generates inertial signals 118 corresponding to their user's movements. The inertial signals 118 of each communication device in the environment can be provided to the backend server as a streaming set of inertial sensor data through an existing local area network, i.e. access point 106 connected to the backend server 100. The inertial signals 118 can also be paired with each communication device's unique identifier (e.g. UID or MAC address). The inertial signals from one of the mobile devices should match the scene motion vectors of one of the users in the video. In particular, the backend server 100 is further operable to track a video motion (e.g. 140) of users 110, 112, 114 captured in the video and input motion signals 118 from the inertial sensors of the mobile communication devices 120, 122, 124.

The backend server can then correlate the video motion of each user and the motion signals of each mobile communication device to associate one of the mobile communication devices with one of the particular tracked users in the video. For example, a person walking with a particular cadence will show impulses in the accelerometer data at that same cadence, which can be correlated. Video analytics are used to make careful time based measurements of the time between each step and matches that with accelerometer data that shows impulses at the same rate as those observed on the video. A person who abruptly changes direction in the video will show abrupt changes in the gyroscope and magnetometer data, which can be correlated. A person standing still will show very little change in inertial sensor data but the start of motion should correlate with the video of person starting to move.

The backend server is further operable to keep a record of video motions 140 and motion signals 118 over time to provide an increased confidence in correlation for longer time periods. For example, the confidence level can increase or decrease over time as the person continues to move around the store and the sensor data continues to match (or not match) the expected movements, respectively. The backend server is further operable to calibrate the signaling and processing delays of the input signals versus the captured video such that the video motion and motion signals are time-aligned so that they can be properly correlated in time.

Each mobile communication device (e.g. 120) can also provide its unique identification (i.e. UID or MAC address) to the backend server 100 in the signals 118 to the network 106 to identify the user (e.g. 110) being tracked in the video. It is envisioned that the mobile device will have an application pre-installed, or installed upon entering the defined area, that will allow its inertial signals and identity to be provided to the backend server.

In the present invention there may be many cameras in an area and many users that need to be tracked. The system described herein makes use of the Wi-Fi™ access point that the mobile device is connected to as a way of reducing the number of correlations of inertial sensor data streams that need to be done for a given number of users in view of any one camera. For example, different mobile device may be connected to different access points in the environment, and the present invention may provide one camera to cover the same area as each access point. Therefore, users in view of that one camera can only be correlated to data streams from mobile devices being served by only that one access point in that coverage area.

In an optional embodiment, the present invention further comprises a locationing system, as is known in the art, operable to determine a location of the mobile device in the environment and associate the location with a particular user in the video. The locationing system includes a set of transmitters 108 operable to send signals 132 at specific times as directed by the backend server 100. The transmitters can be RF devices, such as other access points 106 for example, or can be ultrasonic emitters. The transmitters are located at known fixed positions, typically disposed on the ceiling of the environment in an array or grid. For example, the locationing system includes a plurality of ultrasonic transmitters 108 at known fixed positions in the environment and operable to provide ultrasonic signals 132 to be received by each mobile communication device 120, 122, 124, wherein the mobile device is further operable to measure timing information of these received ultrasonic signals for the backend server 100 to determine a location of each mobile device in the environment, using Time Difference Of Arrival (TDOA) or Time of Arrival (TOA) information for example, as is known in the art. Inasmuch as the mobile device can provide its unique identifier to the backend server, and the server can determine the location of the identified mobile device using the locationing system, and the identified mobile device is associated with a particular user in the video, the backend server can then associate the location with a user in the video, in accordance with the present invention.

In an optional embodiment, once a user has been visually and electronically identified, their identity can be searched in a database to find relevant information for that particular user. For example, if the user is identified as a loyal shopper, a message could be sent to their phone over the local area network telling them of a special offer for items near the location where they are standing or moving. The wireless network can also be used by the shopper to locate a particular item, such as where the item is located in the area, directions to find the item, its cost, etc.

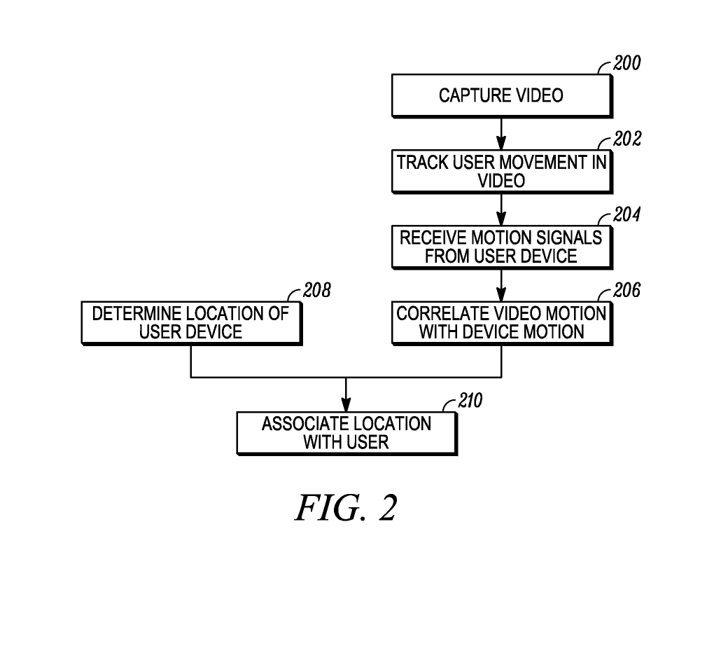

FIG. 2 illustrates a flowchart of a method for identification using video analytics together with inertial sensor data, in accordance with the present invention.

The method starts by capturing 200 video of an environment of a defined area.

The method includes tracking 202 particular users in the captured video.

The method includes receiving 204 motion signals from at least one inertial sensor of at least one mobile communication device being carried by a user. The at least one inertial sensor includes one or more of an accelerometer and a gyroscope. Although magnetometer and a Global Positioning System inputs could also be utilized. Along with the motion signals, an identification (e.g. UID or MAC) of the mobile communication device can be sent to identify the user being tracked in the video.

The method includes correlating 206 the video motion of each tracked user in the captured video and the motion signals of each mobile communication device to associate one of the mobile communication devices with a particular tracked user in the video. A record of the video motions and motion signals can be kept over time to provide an increased confidence in correlation for longer time periods. In other words, using an increased number of motion signatures will improve correlation confidence. If there are significant different signal and processing delays between the imaging and communication systems, then this step can include calibrating the timing of the input signals versus the captured video such that the video motion and motion signals correlation results are time-aligned.

Optionally, the method can include determining 208 a location of the mobile device in the environment using a locationing system, such as an RF or ultrasonic locationing system, and associating 210 the location with a particular user in the video. For example, the locationing system can include a plurality of ultrasonic transmitters at known fixed positions in the environment and operable to provide ultrasonic signals to be received by the mobile communication device, wherein the mobile device is further operable to measure timing information of these received ultrasonic signals for the backend server to determine a location of the mobile device in the environment, using known trilateration techniques for example.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method for identification using video analytics together with inertial sensor data, the method comprising:
capturing video of an environment;
tracking particular users in the captured video;
receiving motion signals from at least one inertial sensor of at least one mobile communication device being carried by a user; and
correlating the video motion of each tracked user in the captured video and the motion signals of each mobile communication device to associate one of the mobile communication devices with a particular tracked user in the video.

2. The method of claim 1, wherein the at least one inertial sensor includes one or more of an accelerometer and a gyroscope.

3. The method of claim 1, wherein receiving also includes receiving an identification from the mobile communication device to identify the user being tracked in the video.

4. The method of claim 1, wherein correlating includes keeping a record of video motions and motion signals over time to provide an increased confidence in correlation for longer time periods.

5. The method of claim 1, wherein correlating includes calibrating the timing of the input signals versus the captured video such that the video motion and motion signals are time-aligned.

6. The method of claim 1, further comprising:
determining a location of the mobile device in the environment using a locationing system; and
associating the location with a particular user in the video.

7. A system for identification using video analytics together with inertial sensor data, the system comprising:
an imaging apparatus operable to capture video of an environment;
a backend server coupled to the imaging device, the server operable to track particular users in the captured video;
a wireless communication network coupled to the backend server; and
at least one mobile communication device operable to be carried by a user and coupled to the backend server through the communication network, the at least one mobile communication device including at least one inertial sensor,
wherein the backend server further operable to track a video motion of users in the video and input motion signals from the inertial sensors of the at least one mobile communication device, the backend server operable to correlate the video motion of each user and the motion signals of each mobile communication device to associate one of the mobile communication devices with a particular tracked user in the video.

8. The system of claim 7, wherein the at least one inertial sensor includes one or more of an accelerometer and a gyroscope.

9. The system of claim 7, wherein mobile communication device also provides an identification to the backend server to identify the user being tracked in the video.

10. The system of claim 7, wherein the backend server is further operable to keep a record of video motions and motion signals over time to provide an increased confidence in correlation for longer time periods.

11. The system of claim 7, wherein the backend server is further operable to calibrate the timing of the input signals versus the captured video such that the video motion and motion signals are time-aligned.

12. The system of claim 7, further comprising a locationing system operable to determine a location of the mobile device in the environment and associate the location with a particular user in the video.

13. The system of claim 12, wherein the locationing system includes a plurality of ultrasonic transmitters at known fixed positions in the environment and operable to provide ultrasonic signals to be received by the mobile communication device, wherein the mobile device is further operable to measure timing information of these received ultrasonic signals for the backend server to determine a location of the mobile device in the environment.

14. The system of claim 7, wherein the imaging apparatus is at least one video camera.
